(19) United States
(12) Patent Application Publication
(10) Pub. No.: US 2026/0221311 A1
(43) Pub. Date: Jul. 30, 2026

(54) TRANSPOSED ELECTRICAL CONDUCTOR AND BUSHING

(71) Applicant: Hitachi Energy Ltd, Zürich (CH)

(72) Inventor: Jan Czyzewski

(21) Appl. No.: 19/143,718

(22) PCT Filed: Sep. 21, 2023
(86) PCT No.: PCT/EP2023/076056

§ 371 Date: Jun. 26, 2025

(30) Foreign Application Priority Data
Dec. 29, 2022 (EP) 22217101.9

(51) Int. Cl. H01B 5/00; H01B 17/58

(52) U.S. Cl. CPC H01B 5/00; H01B 17/583

(57) ABSTRACT

A transposed electrical conductor for electric power transmission at voltages of at least 1 kilovolt (kV) and a bushing are disclosed. The transposed electrical conductor includes at least two electrical conductors comprising a first electrical conductor and a second electrical conductor, wherein each of the at least two electrical conductors comprises at least two partial conductors. The at least two partial conductors comprise a first partial conductor and a second partial conductor. The second partial conductor is a hollow cylinder. The first partial conductor is arranged within the hollow cylinder. The first electrical conductor and the second electrical conductor are electrically connected by a junction. The junction comprises at least two parts being electrically insulated from one another, and a thickness of the second partial conductor is at most 90% of a skin depth at an operating frequency of the transposed electrical conductor.

### CROSS REFERENCE TO RELATED APPLICATIONS

This application is a 35 U.S.C. § 371 national stage application of PCT International Application No. PCT/EP2023/076056 filed on Sep. 21, 2023, which in turn claims priority to European Patent Application No. 22217101.9, filed on Dec. 29, 2022, the disclosures and content of which are incorporated by reference herein in their entireties.

The present disclosure relates to a transposed electrical conductor for power transmission and a bushing.

Typically, ohmic losses in an outer partial conductor of a conventional electrical conductor forming a conventional transposed conductor are generated not only by the alternating current, AC, flowing in that partial conductor, and all eddy currents in that partial conductor generated by its own current, contributing to what is called a skin effect, but additional losses are generated by eddy currents induced in that partial conductor by the magnetic field generated by currents flowing in all the partial conductors located inside that partial conductor. This phenomenon is referred to as the proximity effect.

Such losses reduce power transmission in such conventional transposed electrical conductors. In particular, an operating current transmitted through a conventional transposed electrical conductor is limited by heat generated by the ohmic losses, which are proportional to the AC electric resistance of the partial conductors.

Embodiments of the disclosure relate to a transposed electrical conductor, which has an improved power transmission. Further embodiments of the disclosure relate to a bushing comprising such an electrical conductor.

For example, the transposed electrical conductor is part of bushings, cable terminations, breakers, switches, disconnectors, and the like, or current bars.

According to an embodiment, the transposed electrical conductor is configured for electric power transmission at voltages of at least 1 kV. Thus, the term “power” here and in the following, for example, refers to power transmissions adapted for processing voltages and currents of more than 1 kV and/or more than 250 A, more than 500 A, exemplary voltages up to 1200 kV and/or currents of more than 1000 A.

According to an embodiment, the transposed electrical conductor comprises at least two electrical conductors comprising a first electrical conductor and a second electrical conductor. The at least two electrical conductors are, for example, arranged consecutively along a main extension direction of the transposed electrical conductor.

In particular, the first electrical conductor and the second electrical conductor are arranged next to one another along the main extension direction of the transposed electrical conductor, wherein main extension directions of the respective electrical conductors are arranged on the main extension direction of the transposed electrical conductor.

According to an embodiment of the transposed electrical conductor, each of the at least two electrical conductors comprises at least two partial conductors. For example, each of the electrical conductors comprises a plurality of partial conductors. The partial conductors are each configured to transmit a current.

In particular, the partial conductors are each formed of the same material. The material of the partial conductors comprises an electrically conducting material. In particular, the electrically conducting material comprises or consists of a non-magnetic metal, such as at least one of the following materials: copper, aluminium, aluminium alloy.

For example, the partial conductors of one electrical conductor each extend along the main extension direction of the one electrical conductor. At least two of the conductors, in particular all conductors, have a same length along the main extension direction.

According to an embodiment of the transposed electrical conductor, the at least two partial conductors comprise a first partial conductor and a second partial conductor. For example, each electrical conductor comprises only two partial conductors.

According to an embodiment of the transposed electrical conductor, the second partial conductor is a hollow cylinder.

For example, the hollow cylinder is defined by an inner radius, an outer radius and a height. The height of the hollow cylinder corresponds to the length of a corresponding partial conductor. The inner radius is in particular smaller than the outer radius and the height extends along a common cylinder axis. The common cylinder axis extends along the main extension direction of the electrical conductor. For example, a shell of the hollow cylinder is formed by the corresponding partial conductor, in particular the second partial conductor. The shell of the hollow cylinder comprises, for example, an inner side surface corresponding to the inner radius and an outer side surface corresponding to the outer radius. The inner side surface and the outer side surface extend along the common cylinder axis, in particular completely, along the height. The inner side surface faces the common cylinder axis and the outer side surface faces away from the common cylinder axis. The inner side surface and the outer side surface surround the common cylinder axis in particular completely thereby enclosing a hollow space.

For example, the shell of the hollow cylinder further comprises a first annulus base and a second annulus base being arranged opposite to one another along the common cylinder axis. In particular, the first annulus base and the second annulus base are perpendicular to the common cylinder axis. Furthermore, in view along the common cylinder axis, the first annulus base and the second annulus base overlap in particular congruently with one another.

For example, the corresponding partial conductor being a hollow cylinder can deviate from a shape of a hollow cylinder due to production tolerances. This is to say that a cross section perpendicular to the common cylinder axis of the shell is approximately circular. “Approximately circular” can mean here and in the following that a cross section perpendicular to the common cylinder axis of a partial conductor can deviate by at most 5% or at most 1% from a circular shape.

According to an embodiment of the transposed electrical conductor, the first partial conductor is arranged within the hollow cylinder. This is to say that the first partial conductor is arranged within the hollow space of the second partial conductor.

The shell of the second partial conductor completely surrounds the first partial conductor, for example. In particular, an outer side surface of the first partial conductor faces the inner side surface of the second partial conductor.

According to the embodiment of the transposed electrical conductor arrangement, the first electrical conductor and the second electrical conductor are electrically connected by a junction. In particular, the junction is configured to transmit the electric current from the first electrical conductor to the second electrical conductor.

In particular, the junction comprises an electrically conducting material. For example, the electrically conducting material comprises or consists of a non-magnetic metal, such as at least one of the following materials: copper, aluminium, aluminium alloy. The junction can be the same material as the electrical conductors or can comprise or consist of a different material from the electrical conductors.

According to an embodiment of the transposed electrical conductor, a thickness of the second partial conductor is at most 90% of a skin depth at an operating frequency of the transposed electrical conductor.

Each of the partial conductors of the transposed electrical conductor is configured to transmit an alternating electric current, AC, and/or a direct electric current, DC, with an AC component. The skin depth δ_{S} is defined as follows:

$${δ}_{s} = \sqrt{\frac{ρ}{π {μ}_{0} {μ}_{r} f}} ,$$

where ρ is the resistivity of the respective partial conductor, f is the frequency of the operating AC current or of the AC component of the operating current of the transposed electrical conductor and thus of the respective partial conductor, μ₀ is the magnetic permeability of vacuum and μᵣ is the relative magnetic permeability of the respective partial conductor. For example, for non-magnetic materials, μᵣ is approximately 1.

In particular, the thickness is defined in radial direction of the common cylinder axis.

In summary, such a method can provide, inter alia, the following advantages. With a thickness of the second partial conductor being at most 90% of the corresponding skin depth, current ratings can be increased with respect to conventional transposed electrical conductors having typically larger wall thicknesses. Additionally or alternatively a second partial conductor with a thickness being at most 90% of the corresponding skin depth—by having the same current ratings of a conventional transposed electrical conductor—can have a smaller size due to the reduced thickness. This advantageously reduces material costs. Further, with such a second partial conductor, a replacement of partial conductors formed of copper by aluminium without changing a diameter can be performed.

For example, within such a transposed electrical conductor comprising the at least two electrical conductors, e.g., of equal length, are connected by the junction. Each of the two electrical conductors comprises at least two partial conductors which are electrically insulated from each other.

The partial conductors are typically made as a concentric arrangement, so that there is an innermost partial conductor being the first partial conductor, and an outermost partial conductor being the second partial conductor.

The junction commutes the currents of the partial conductors, so that the current from the innermost partial conductor of the first conductor flows to the outermost partial conductor of the second conductor and the current from the outermost partial conductor of the first conductor flows to the innermost partial conductor of the second conductor. For example, at each of the two ends of the transposed electrical conductor all the partial conductors are electrically connected with each other, so that the total current flowing into the transposed conductor can be divided between all the partial conductors.

The junctions and the electrical conductors are arranged for example in such a way that the current, when flowing from one end of the transposed electrical conductor to its other end, flows an approximately same distance through differently positioned partial conductors. For example, for a transposed conductor having two partial conductors and consisting of two electrical conductors of equal length connected by the junction, the current flowing into the innermost partial conductor of the first electrical conductor commutes to the outermost partial conductor of the second electrical conductor and vice versa. In such a way, the part of the current entering the innermost partial conductor at the first end, flows a half of the length of the transposed electrical conductor through the innermost partial conductor and another half of the length through the outermost partial conductor.

The same occurs with the current entering the outermost partial conductor of the first electrical conductor. Because of the equal nature of these two current paths, the total current flowing through the transposed electrical conductor is divided into two approximately equal parts, one current path comprising the innermost partial conductor of the first electrical conductor and the outermost partial conductor of the second electrical conductor, and the second path vice versa.

With a transposed electrical conductor described herein, approximately 30% more current can be transmitted with respect to conventional transposed electrical conductors due to the specified wall thicknesses. Further, an overload capability of transposed electrical conductors described herein is further improved.

In turn, thicknesses of more than 90% of the corresponding skin depth, as typically used in conventional transposed electrical conductors, lead to a significant increase of the losses, and at the same time to an increase of the material weight and consumption.

According to a further embodiment of the transposed electrical conductor, the first partial conductor is a solid cylinder. In contrast to a hollow cylinder described herein above, the solid cylinder does not have a hollow space. In particular, the solid cylinder is a bulk cylinder.

For example, the solid cylinder is defined by a radius and a height. The height of the solid cylinder corresponds to the length of the first partial conductor, wherein the height extends along the common cylinder axis.

For example, the solid cylinder further comprises a first base and a second base being arranged opposite to one another along the common cylinder axis. In particular, the first base and the second base are perpendicular to the common cylinder axis.

For example, the first partial conductor can deviate from a shape of a solid cylinder due to production tolerances. This is to say that a cross section perpendicular to the common cylinder axis of the first partial conductor is approximately circular.

For example, a bulk of the solid cylinder is formed by the first partial conductor, comprising an outer side surface corresponding to the radius. The outer side surface of the solid cylinder extends along the common cylinder axis, in particular completely, along the height.

In particular, the outer side surface of the solid cylinder of the first partial conductor faces the inner side surface of the hollow cylinder of the second partial conductor. In particular, the outer side surface of the solid cylinder of the first partial conductor is spaced apart in the radial direction from the inner side surface of the hollow cylinder of the second partial conductor by a first gap.

According to a further embodiment of the transposed electrical conductor, the first partial conductor is a hollow cylinder. In particular, the outer side surface of the hollow cylinder of the first partial conductor faces the inner side surface of the hollow cylinder of the second partial conductor. In particular, the outer side surface of the hollow cylinder of the first partial conductor is spaced apart in the radial direction from the inner side surface of the hollow cylinder of the second partial conductor by the first gap.

The first gap is, for example, configured to electrically insulate the first partial conductor from the second partial conductor. For example, the first gap can comprise an electrically insulating material. In particular, the electrically insulating material is completely arranged in the first gap.

According to a further embodiment of the transposed electrical conductor, the first electrical conductor and the second electrical conductor have approximately the same length. “Approximately the same length” means here and in the following that the electrical conductors, in particular all electrical conductors, have the same length, wherein the lengths do not deviate by more than 1% from one another. Due to such lengths, a current distribution within each of the electrical conductors is equal to one another.

According to a further embodiment of the transposed electrical conductor, the thickness of the second partial conductor is at most 80% of the skin depth at the operating frequency of the transposed electrical conductor.

An AC resistance can be calculated for a virtual second partial conductor being a hollow cylinder dependent on a thickness of the virtual second partial conductor. The calculated AC resistance has, for example, a local minimum. In particular, the minimum in AC resistance corresponds to a thickness of the virtual second partial conductor of around 80% of the skin depth. Such a thickness of the virtual second partial conductor is, for example, equivalent to an AC resistance factor of the virtual second partial conductor of less than around 1.3. The AC resistance factor is understood as a ratio of losses of the AC current flowing within a partial conductor and losses of a DC current of the magnitude equal to the effective magnitude of that AC current and flowing within that partial conductor. The results concerning the calculated virtual second partial conductor can be applied one to one to the second partial conductor. In this way, a significant reduction in losses can be obtained in a transposed electrical conductor advantageously having a reduced mass and a reduced material consumption.

According to a further embodiment of the transposed electrical conductor, the thickness of the second partial conductor is at least 50% of the skin depth at the operating frequency of the transposed electrical conductor.

Typically, an application of a smaller thickness of the second partial conductor, when maintaining the same cross section area of the second partial conductor, requires an increase of the outer diameter of the conductor. However, the benefits from the very slightly lower AC-resistance factor do not compensate for the disadvantages related to an increase of the diameter, of the material consumption and of the mass for the whole transposed electrical conductor. However, with the thickness of the second partial conductor being at least 50%, the above listed disadvantages are advantageously mitigated.

This is to say that for thicknesses of the second partial conductor being at least 50% and at most 90%, in particular 80% of the skin depth at the operating frequency of the transposed electrical conductor, the AC losses are advantageously surprisingly low in combination with saving material costs.

According to a further embodiment of the transposed electrical conductor, each of the at least two electrical conductors comprises at least three partial conductors, wherein the at least three partial conductors comprise additionally a third partial conductor. This is to say that each of the electrical conductors comprises the first partial conductor, the second partial conductor, and the third partial conductor.

For a transposed electrical conductor having three partial conductors, the innermost, i.e. the first partial conductor, the intermediate, i.e. the second partial conductor, and the outermost partial conductor, i.e. the third partial conductor, consists of at least three electrical conductors of approximately equal length and two junctions connecting the electrical conductors. In such electrical conductors, three current paths are formed, one comprising the innermost partial conductor of the first electrical conductor, the intermediate partial conductor of the second electrical conductor, and the outermost partial conductor of the third electrical conductor. The other two current paths comprise the two different permutations of the partial conductors. At the end of the transposed electrical conductor, the current is divided into three approximately equal parts, so that approximately one third of the current flows through each of the current paths.

According to a further embodiment of the transposed electrical conductor, the third partial conductor is a hollow cylinder, and the second partial conductor is arranged within the hollow cylinder of the third partial conductor.

A shell of the third partial conductor completely surrounds the first partial conductor and the second partial conductor, for example. In particular, the outer side surface of the second partial conductor faces an inner side surface of the third partial conductor. In particular, the outer side surface of the second partial conductor is spaced apart in the radial direction from the inner side surface of the third partial conductor by a second gap.

The second gap is, for example, configured to electrically insulate the second partial conductor from the third partial conductor. For example, the second gap can comprise the electrically insulating material. In particular, the electrically insulating material is completely arranged in the second gap.

According to a further embodiment of the transposed electrical conductor, a thickness of the third partial conductor is at most 75% or at most 65% and/or at least 40% of a skin depth at an operating frequency of the transposed electrical conductor.

With such a combination of thicknesses of the second partial conductor and the third partial conductor, the AC losses are advantageously surprisingly low in combination with saving material costs.

According to a further embodiment of the transposed electrical conductor, each of the at least two electrical conductors comprises at least four partial conductors, wherein the at least four partial conductors comprise additionally a fourth partial conductor. This is to say that each electrical conductor comprises the first partial conductor, the second partial conductor, the third partial conductor and the fourth partial conductor.

Analogously to the transposed electrical conductor with three partial conductors, for a transposed electrical conductor comprising four electrical conductors each comprising four partial conductors and being connected by three junctions, typically four current paths are formed and approximately one fourth of the total current flows through each of the parts.

In particular, additional losses caused by the proximity effect in the second partial conductor are generated by the current flowing in the innermost partial conductor, i.e., by a current which is approximately equal to the value of its own current. Similarly, the additional losses in the third partial conductor are generated by a current which is approximately twice the value of its own current. For a fourth partial conductor, the additional losses are generated by a current of approximately three times the value of its own current. Because of that, the contribution of those additional losses are the larger, the more outer position of the partial conductor is. However, such losses are additionally reduced with the proposed thicknesses of the partial conductors.

According to a further embodiment of the transposed electrical conductor, the fourth partial conductor is a hollow cylinder, and the third partial conductor is arranged within the hollow cylinder of the fourth partial conductor.

A shell of the fourth partial conductor completely surrounds the first partial conductor, the second partial conductor and the third partial conductor, for example. In particular, an outer side surface of the third partial conductor faces an inner side surface of the fourth partial conductor. In particular, the outer side surface of the third partial conductor is spaced apart in the radial direction from the inner side surface of the fourth partial conductor by a third gap.

The third gap is, for example, configured to electrically insulate the third partial conductor from the fourth partial conductor. For example, the third gap can comprise the electrically insulating material. In particular, the electrically insulating material is completely arranged in the third gap.

According to a further embodiment of the transposed electrical conductor, a thickness of the fourth partial conductor is at most 65% or at most 55% and/or at least 30% of a skin depth at an operating frequency of the transposed electrical conductor.

With such a combination of thicknesses of the second partial conductor, the third partial conductor and the fourth partial conductor, the AC losses are advantageously surprisingly even lower in combination with saving material costs.

According to a further embodiment of the transposed electrical conductor, the junction electrically connects the first partial conductor of the first electrical conductor to the second partial conductor of the second electrical conductor, and the junction electrically connects the second partial conductor of the first electrical conductor to the first partial conductor of the second electrical conductor.

According to a further embodiment of the transposed electrical conductor, the junction electrically connects the first partial conductor of the first electrical conductor to the second partial conductor of the second electrical conductor, the junction electrically connects the second partial conductor of the first electrical conductor to the third partial conductor of the second electrical conductor, and the junction electrically connects the third partial conductor of the first electrical conductor to the first partial conductor of the second electrical conductor.

According to a further embodiment of the transposed electrical conductor, the junction electrically connects the first partial conductor of the first electrical conductor to the second partial conductor of the second electrical conductor, the junction electrically connects the second partial conductor of the first electrical conductor to the third partial conductor of the second electrical conductor, the junction electrically connects the third partial conductor of the first electrical conductor to the fourth partial conductor of the second electrical conductor, and the junction electrically connects the fourth partial conductor of the first electrical conductor to the first partial conductor of the second electrical conductor.

In particular, the transposed electrical conductor can comprise a plurality of electrical conductors, wherein directly neighbouring electrical conductors are electrically connected by the junction.

According to a further embodiment of the transposed electrical conductor, the junction comprises at least two parts being electrically insulated from one another. In particular, an amount of parts of the junction is the amount of partial conductors of one of the electrical conductors.

For example, all parts of the junction are electrically insulated from one another.

For example, if each of the electrical conductors comprises the first partial conductor and the second partial conductor, the junction has two parts. In this case, a first part of the junction electrically connects the first partial conductor of the first electrical conductor to the second partial conductor of the second electrical conductor and a second part of the junction electrically connects the second partial conductor of the first electrical conductor to the first partial conductor of the second electrical conductor.

If each of the electrical conductors comprises the first partial conductor, the second partial conductor and the third partial conductor, the junction has three parts, for example.

In this case, a first part of the junction electrically connects the first partial conductor of the first electrical conductor to the second partial conductor of the second electrical conductor, a second part of the junction electrically connects the second partial conductor of the first electrical conductor to the third partial conductor of the second electrical conductor and a third part of the junction electrically connects the third partial conductor of the first electrical conductor to the first partial conductor of the second electrical conductor.

If each of the electrical conductors comprises the first partial conductor, the second partial conductor, the third partial conductor and the fourth partial conductor, the junction has four parts, for example. In this case, a first part of the junction electrically connects the first partial conductor of the first electrical conductor to the second partial conductor of the second electrical conductor, a second part of the junction electrically connects the second partial conductor of the first electrical conductor to the third partial conductor of the second electrical conductor, a third part of the junction electrically connects the third partial conductor of the first electrical conductor to the fourth partial conductor of the second electrical conductor and a fourth part of the junction electrically connects the fourth partial conductor of the first electrical conductor to the first partial conductor of the second electrical conductor.

According to a further embodiment of the transposed electrical conductor, at least one part of the at least two parts comprises at least two sub-parts being formed in one piece. Thereby, the sub-parts form a mechanically stable and electrically conductive connection.

According to a further embodiment of the transposed electrical conductor, a transposing portion of each part has a length along the main extension direction of at most 300% and/or at least 30% of the skin depth at an operating frequency of the transposed electrical conductor. For example, the lengths of different parts can be different to one another in the main extension direction.

The transposing portion of each part of the junction is, for example, a portion of the junction which leads the current from a radial position of one of the partial conductors to a radial position of the respective outer or respective inner partial conductor. For example, the transposing portion is the portion of the junction through which the current flows in a substantially radial direction from a radial position of one of the partial conductors to a radial position of the respective outer or respective inner partial conductor, and thus the transposing portion has a length along the common cylinder axis. In particular, the length of the transposing portion is the length of the portion of the element of the junction, wherein the very part where the current commutes from the more outer to the more inner layer of the partial conductor.

Typically, if the part is too short, a large local current density occurs in a region of the junction. Furthermore, if the part is too long, large circulating currents are induced in the region of the junction. These effects lead to large losses in the region of the junction. However, with the part or the parts having the indicated length dependent on the skin depth, the stated disadvantages are advantageously mitigated.

A further embodiment relates to a bushing with a transposed electrical conductor described herein above. Therefore, the features as described in connection with the transposed electrical conductor are also applicable for the bushing and vice versa.

The accompanying Figures are included to provide a further understanding. In the Figures, elements of the same structure and/or functionality may be referenced by the same reference signs. It is to be understood that the embodiments shown in the Figures are illustrative representations and are not necessarily drawn to scale.

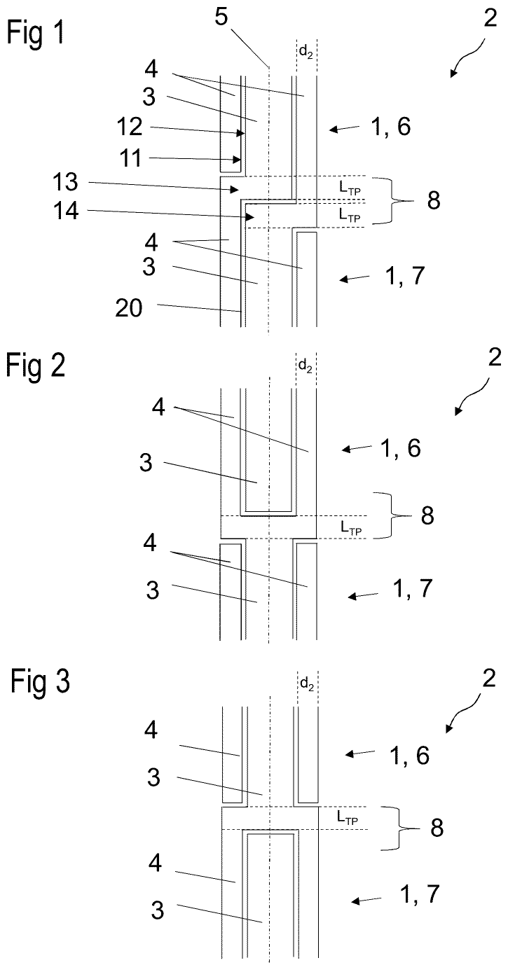

FIG. 1 is a schematic view of a transposed electrical conductor with electrical conductors according to an exemplary embodiment,

FIGS. 2 and 3 are schematic views of a transposed electrical conductor with electrical conductors according to an exemplary embodiment,

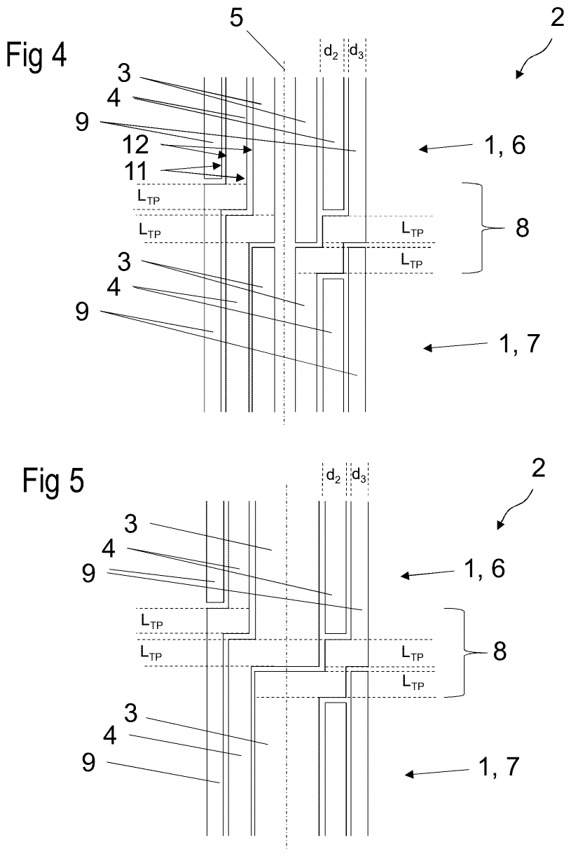

FIGS. 4 and 5 are schematic views of a transposed electrical conductor with electrical conductors each according to an exemplary embodiment,

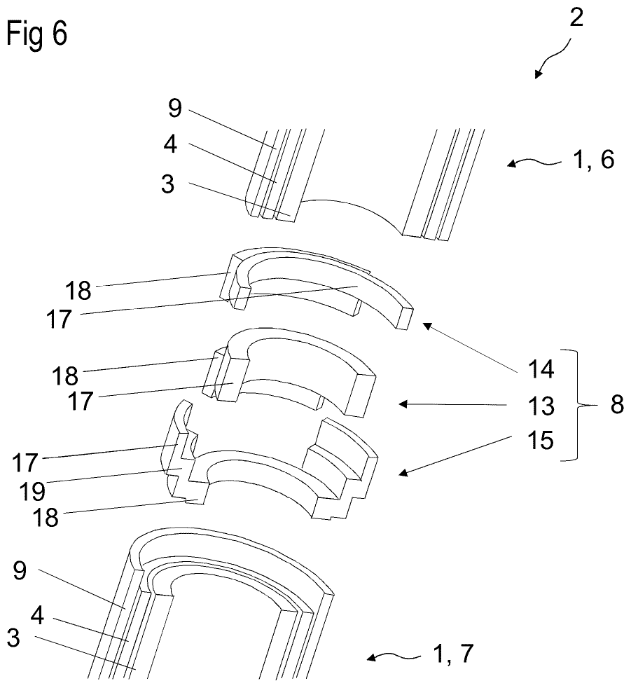

FIG. 6 is a schematic view of a transposed electrical conductor with electrical conductors and the junction according to an exemplary embodiment, and

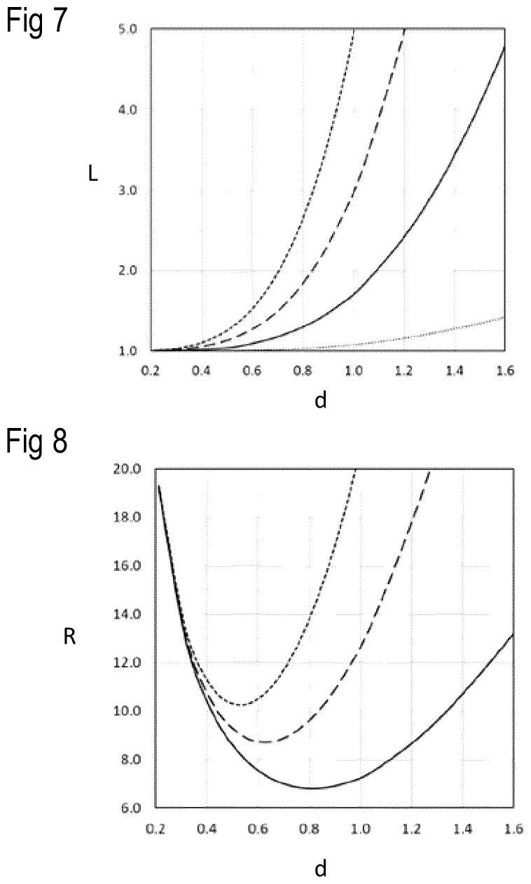

FIGS. 7 and 8 are exemplary diagrams.

The transposed electrical conductor 2 according to the exemplary embodiment of FIG. 1 comprises two electrical conductors 1, in particular a first electrical conductor 6 and a second electrical conductor 7. Each of the electrical conductors 1 has a first partial conductor 3 and a second partial conductor 4.

The first partial conductor 3 is a solid cylinder and the second partial conductor 4 is a hollow cylinder. The first partial conductor 3 is arranged within the hollow cylinder of the second partial conductor 4.

The solid cylinder as well as the hollow cylinder both extend along a common cylinder axis 5. An outer side surface 12 of the solid cylinder being the first partial conductor 3 faces an inner side surface 11 of the hollow cylinder being the second partial conductor 4. The outer side surface 12 of the first partial conductor 3 and the inner side surface 11 of the second partial conductor 4 are separated in space via a first gap 20. The first gap 20 is further configured to electrically insulate the first partial conductor 3 from the second partial conductor 4.

The first partial conductor 3 of the first electrical conductor 6 is electrically connected to the second partial conductor 4 of the second electrical conductor 7 via a junction 8, in particular a first part 13 of the junction 8.

Further, the second partial conductor 4 of the first electrical conductor 6 is electrically connected to the first partial conductor 3 of the second electrical conductor 7 via the junction 8, in particular a second part 14 of the junction 8.

A transposing portion of each part of the junction, i.e. a portion through which the current flows in the substantially radial direction from the radial position of one partial conductor to the radial position of the other one, has a length L_{TP} along the common cylinder axis 5. The length of the transposing portion L_{TP} along the common cylinder axis 5, which is a main extension direction of the electrical conductors 1, is at most 300% and/or at least 30% of a skin depth at an operating frequency of the transposed electrical conductor 2.

Furthermore, a thickness in radial direction of the common cylinder axis 5 of the second partial conductor 4 is at most 90% of the skin depth at the operating frequency of the transposed electrical conductor 2. The thickness of the second partial conductor d₂ is at least 50% of the skin depth at the operating frequency of the transposed electrical conductor 2.

Such a maximal and minimal thickness for electrical conductors 1 in a transposed electrical conductor 2 provide AC losses, which are advantageously surprisingly low in combination with saving material costs.

The transposed electrical conductor 2 according to the exemplary embodiment of FIG. 2 is a cross sectional view in radial direction, which is rotated by 90° with respect to the transposed electrical conductor 2 according to the exemplary embodiment of FIG. 3.

The transposed electrical conductor 2 according to the exemplary embodiment of FIG. 4 comprises in comparison to one of the electrical conductors 1 of FIG. 1, 2 or 3 electrical conductors 1 with a first partial conductor 3, a second partial conductor 4 and a third partial conductor 9. Each of the partial conductors are formed of a hollow cylinder. The first partial conductor 3 is arranged within the second partial conductor 4. Further, the first partial conductor 3 and the second partial conductor 4 are arranged within the third partial conductor 9. This means that the first partial conductor 3 has a diameter which is smaller than a diameter of the second partial conductor 4 and the diameter of the second partial conductor 4 is smaller than a diameter of the third partial conductor 9.

Furthermore, a thickness in radial direction of the common cylinder axis 5 of the second partial conductor 4 is at most 90% of the skin depth at the operating frequency of the transposed electrical conductor 2 and a thickness in radial direction of the common cylinder axis 5 of the third partial conductor 9 is at most 75% of the skin depth at the operating frequency of the transposed electrical conductor 2. The thickness of the second partial conductor d₂ is at least 50% of the skin depth at the operating frequency of transposed electrical conductor 2 and the thickness of the third partial conductor d₃ is at least 40% of the skin depth at the operating frequency of the transposed electrical conductor 2.

The length of the transposing portion L_{TP} corresponds to the lengths described in connection with FIG. 1.

In particular, the first partial conductor 3 of the first electrical conductor 6 is electrically connected to the second partial conductor 4 of the second electrical conductor 7. Further, the second partial conductor 4 of the first electrical conductor 6 is electrically connected to the third partial conductor 9 of the second electrical conductor 7. The third partial conductor 9 of the first electrical conductor 6 is electrically connected to the first partial conductor 3 of the second electrical conductor 7.

The transposed electrical conductor 2 according to the exemplary embodiment of FIG. 5 comprises in comparison to the exemplary embodiment of FIG. 4 a first partial conductor 3, which is a solid cylinder, as described in connection with FIG. 1.

The transposed electrical conductor 2 according to the exemplary embodiment of FIG. 6 comprises, as shown in FIG. 4, a first electrical conductor 6 and a second electrical conductor 7 each having a first partial conductor 3, a second partial conductor 4 and a third partial conductor 9, each being a hollow cylinder.

The third partial conductor 9 of the second electrical conductor 7 protrudes in direction of the common cylinder axis 5 beyond the first partial conductor 3 and the second partial conductor 4, on a side of the second electrical conductor 7 facing the first electrical conductor 6. This is to say that the third partial conductor 9 of the second electrical conductor 7 has a length along the common cylinder axis 5, which is larger than a length of the first partial conductor 3 and the second partial conductor 4. Thus, an annulus base of the third partial conductor 9 is closer to the neighbouring electrical conductor than the annulus bases of the first partial conductor 3 and/or the second partial conductor 4.

It is conceivable that the second partial conductor 4 of the second electrical conductor 7 protrudes in direction of the common cylinder axis 5 beyond the first partial conductor 3, at the side facing the first electrical conductor 6. This is to say that the second partial conductor 4 of the second electrical conductor 7 has a length along the common cylinder axis 5, which is larger than a length of the first partial conductor 3. Thus, an annulus base of the second partial conductor 4 is closer to the neighbouring electrical conductor than the annulus base of the first partial conductor 3. The annulus base of the second partial conductor 4 is arranged between annulus base of the first partial conductor 3 and the annulus base of the third partial conductor 9 along the common cylinder axis 5.

The junction 8 has a first part 13 electrically connecting the first partial conductor 3 of the first electrical conductor 6 with the second partial conductor 4 of the second electrical conductor 7. The first part 13 has a first sub-part 17 and a second sub-part 18. The first sub-part 17 is in direct and immediate contact to the annulus base of the first partial conductor 3 of the first electrical conductor 6.

Further, the second sub-part 18 is in direct and immediate contact to the annulus base of the second partial conductor 4 of the second electrical conductor 7. The first sub-part and the second sub-part are formed in one piece. Further, the first sub-part 17 is for example brazed to the first partial conductor 3 of the first electrical conductor 6 and the second sub-part 18 is for example brazed to the second partial conductor 4 of the second electrical conductor 7.

The junction 8 further has a second part 14 electrically connecting the second partial conductor 4 of the first electrical conductor 6 with the third partial conductor 9 of the second electrical conductor 7. The second part 14 has a first sub-part 17 and a second sub-part 18. The first sub-part 17 is in direct and immediate contact to the annulus base of the second partial conductor 4 of the first electrical conductor 6. Further, the second sub-part 18 is in direct and immediate contact to the annulus base of the third partial conductor 9 of the second electrical conductor 7. The first sub-part and the second sub-part are formed in one piece. Further, the first sub-part 17 is for example brazed to the second partial conductor 4 of the first electrical conductor 6 and the second sub-part 18 is for example brazed to the third partial conductor 9 of the second electrical conductor 7.

The junction 8 additionally has a third part 15 electrically connecting the third partial conductor 9 of the first electrical conductor 6 with the first partial conductor 3 of the second electrical conductor 7. The third part 15 has a first sub-part 17, a second sub-part 18 and a third sub-part 19. The first sub-part 17 is in direct and immediate contact to the annulus base of the third partial conductor 9 of the first electrical conductor 6. Further, the second sub-part 18 is in direct and immediate contact to the annulus base of the first partial conductor 3 of the second electrical conductor 7. The third sub-part 19 electrically connects the first sub-part 17 with the second sub-part 18.

The first sub-part and the third sub-part as well as the third sub-part and the second sub-part are formed in one piece. Further, the first sub-part 17 is for example brazed to the third partial conductor 9 of the first electrical conductor 6 and the second sub-part 18 is for example brazed to the first partial conductor 3 of the second electrical conductor 7.

For example, the sub-parts being in direct and immediate contact to the annulus bases, cover the respective annulus bases by at least 30% or at least 40%. Due to such a comparatively large interface of annulus base and sub-parts, the transmission of power is advantageously effective.

The exemplary diagram of FIG. 7 shows an AC-resistance factor L on the y-axis, being representative for losses of an AC current flowing within a partial conductor divided by losses of a DC current of the magnitude equal to the effective magnitude of the AC current when flowing within that partial conductor, dependent on the thickness d of the partial conductor, as shown on the x-axis. The thickness d is indicated in the units of the skin depth. The solid line is characteristic for a second partial conductor 4, the dashed line with wide gaps is characteristic for a third partial conductor 9 and the dashed line with small gaps is characteristic for a fourth partial conductor 10. The dotted line is characteristic for a first partial conductor 3, which is a hollow cylinder.

The exemplary diagram of FIG. 8 shows an AC-resistance R per unit length in μΩ/m on the y-axis dependent on the thickness d of the partial conductor, as shown on the x-axis. The thickness d is indicated in the units of the skin depth. The solid line is characteristic for a second partial conductor 4, the dashed line with wide gaps is characteristic for a third partial conductor 9 and the dashed line with small gaps is characteristic for a fourth partial conductor 10.

### REFERENCE SIGNS

1 Electrical conductor
2 Transposed electrical conductor
3 first partial conductor
4 second partial conductor
5 common cylinder axis
6 first electrical conductor
7 second electrical conductor
8 junction
9 third partial conductor
10 fourth partial conductor
11 inner side surface
12 outer side surface
13 first part
14 second part
15 third part
16 fourth part
17 first sub-part
18 second sub-part
19 third sub-part
20 gap
d₂ thickness of the second partial conductor
d₃ thickness of the third partial conductor d₄ thickness of the fourth partial conductor
L_{TP} length of the transposing portion
d thickness
L AC resistance factor
R AC resistance

1. A transposed electrical conductor for electric power transmission at voltages of at least 1 kilovolt (kV), with
at least two electrical conductors comprising a first electrical conductor and a second electrical conductor, wherein
each of the at least two electrical conductors comprises at least two partial conductors,
the at least two partial conductors comprise a first partial conductor and a second partial conductor,
the second partial conductor is a hollow cylinder,
the first partial conductor is arranged within the hollow cylinder,
the first electrical conductor and the second electrical conductor are electrically connected by a junction,
the junction comprises at least two parts being electrically insulated from one another, and
a thickness of the second partial conductor is at most 90% of a skin depth at an operating frequency of the transposed electrical conductor.

2. A transposed electrical conductor according to claim 1, wherein
the first partial conductor is a solid cylinder, or
the first partial conductor is a hollow cylinder.

3. A transposed electrical conductor according to claim 1, wherein the first electrical conductor and the second electrical conductor have approximately the same length.

4. A transposed electrical conductor according to claim 1, wherein the thickness of the second partial conductor is at most 80% of the skin depth at the operating frequency of the transposed electrical conductor.

5. A transposed electrical conductor according to claim 1, wherein the thickness of the second partial conductor is at least 50% of the skin depth at the operating frequency of the transposed electrical conductor.

6. A transposed electrical conductor according to claim 1, wherein
each of the at least two electrical conductors comprises at least three partial conductors, wherein
the at least three partial conductors comprise additionally a third partial conductor,
the third partial conductor is a hollow cylinder,
the second partial conductor is arranged within the hollow cylinder of the third partial conductor, and
a thickness of the third partial conductor is at most 75% or at most 65% and/or at least 40% of a skin depth at an operating frequency of the transposed electrical conductor.

7. A transposed electrical conductor according to claim 6, wherein
each of the at least two electrical conductors comprises at least four partial conductors, wherein
the at least four partial conductors comprise additionally a fourth partial conductor,
the fourth partial conductor is a hollow cylinder,
the third partial conductor is arranged within the hollow cylinder of the fourth partial conductor, and
a thickness of the fourth partial conductor is at most 65% or at most 55% and/or at least 30% of a skin depth at an operating frequency of the transposed electrical conductor.

8. A transposed electrical conductor according to claim 1, wherein
the junction electrically connects the first partial conductor of the first electrical conductor to the second partial conductor of the second electrical conductor, and
the junction electrically connects the second partial conductor of the first electrical conductor to the first partial conductor of the second electrical conductor.

9. A transposed electrical conductor according to claim 1, wherein
the junction electrically connects the first partial conductor of the first electrical conductor to the second partial conductor of the second electrical conductor,
the junction electrically connects the second partial conductor of the first electrical conductor to the third partial conductor of the second electrical conductor, and
the junction electrically connects the third partial conductor of the first electrical conductor to the first partial conductor of the second electrical conductor.

10. A transposed electrical conductor according to claim 1, wherein
the junction electrically connects the first partial conductor of the first electrical conductor to the second partial conductor of the second electrical conductor,
the junction electrically connects the second partial conductor of the first electrical conductor to the third partial conductor of the second electrical conductor,
the junction electrically connects the third partial conductor of the first electrical conductor to the fourth partial conductor of the second electrical conductor, and
the junction electrically connects the fourth partial conductor of the first electrical conductor to the first partial conductor of the second electrical conductor.

11. A transposed electrical conductor according to claim 1, wherein at least one part of the at least two parts comprises at least two sub-parts being formed in one piece.

12. A transposed electrical conductor according to claim 1, wherein a transposing portion of each part has a length along the main extension direction of at most 300% and/or at least 30% of the skin depth at an operating frequency of the transposed electrical conductor.

13. A bushing comprising the transposed electrical conductor comprising electrical conductors according to claim 1.
